(19) United States
(12) Patent Application Publication
(10) Pub. No.: US 2004/0063802 A1
(43) Pub. Date: Apr. 1, 2004

(54) Adhesive useful in the manufacture of packaging materials

(76) Inventors: David W. Lydzinski, Belle Mead, NJ (US); Kent F. Rothammer, Collierville, TN (US); Timothy M. Longman, Rosemount, MN (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 10/261,965

(22) Filed: Oct. 1, 2002

(51) Int. Cl. C08J 9/00

(52) U.S. Cl. 521/134

(57) ABSTRACT

A foamed adhesive finds use in the manufacture of packaging materials, and is particularly useful in the manufacture of multi-ply packaging materials such as bags.

### FIELD OF THE INVENTION

The invention relates to improvements in and or relating to packaging materials, more specifically to adhesives useful in the manufacture of e.g., bags. In a preferred embodiment, a foamed water-based adhesive is used to manufacture multi-ply packaging materials.

### BACKGROUND OF THE INVENTION

Water-based adhesives are commonly used to manufacture paper, multi-wall and specialty bags. In the manufacture of bags, a water-based adhesive is generally applied to a substrate and then mated to another similar or dissimilar substrate to form a fold or multi-layered structure. While water-based adhesives have been used in the manufacture of bags, water-based adhesives require significant drying times and the water contained within them often causes the substrates to warp, wrinkle, curl or bend.

In today's competitive marketplace it is important to maintain manufacturing costs at a minimum. This includes reducing costs associated with the packaging of the goods and the like. Packaging costs, of course, include the costs of the materials required to make the package (e.g., paper, plastic, adhesive and the like) and costs associated with packaging defects (e.g., materials that must be discarded due to unacceptable strength, appearance or the like).

A need continues to exist for adhesives that are safe and effective for use in the manufacture of packaging materials, in particular bags including multi-ply bags, that can provide a substantial savings in terms of cost and, in addition, a reduction in packaging defects. The current invention addresses this need.

### SUMMARY OF THE INVENTION

The invention provides an adhesive that can advantageously be used in the production of packaging materials, and in particular bags. The adhesive is safe and effective and exhibits reduced moisture content and faster set times. Since use of the invention reduces or eliminates warpage and the like commonly encountered using prior art water-based adhesives, the invention provides a substantial cost savings both in terms of raw materials and in terms of reduction of defective material.

One aspect of the invention is directed to an adhesive, more particularly a water-based adhesive composition comprising a polymer having a vinyl acetate component and an acrylic component. In preferred embodiments the adhesive comprises a mixture of such polymers. Particularly preferred embodiments comprise a blend of at least a first polymer emulsion and a second polymer emulsion. Particularly preferred for use are adhesives comprising a blend of a vinyl acetate/ethylene/dioctylmaleate terpolymer and a vinyl acetate/butyl acrylate copolymer. In practicing the invention, the adhesive will preferably be used in its foamed state.

Another aspect of the invention is directed to an article of manufacture comprising the adhesive described herein. The article is preferable a packaging material such as but not limited to bags.

Packaging materials encompassed by the invention generally comprise a first substrate having opposing first and second major surfaces and at least one second substrate having opposing first and second major surfaces, wherein at least one of the first and second major surfaces of said first substrate is bonded to at least one of the first and second major surface of the second substrate with the foamed adhesive described herein.

Preferred packaging materials are multi-ply packaging materials. Multi-ply packages for e.g., housing materials will generally comprise at least one side wall, said side wall comprising at least an inner ply and an outer ply, wherein a first ply is bonded to a second ply with the foamed adhesive of the invention.

Yet another aspect of the invention is directed to a method for bonding materials together which comprises applying the adhesive or the foamed adhesive composition described herein to a first substrate, bringing a second substrate in contact with the adhesive composition applied to the first substrate, and subjecting the applied composition to conditions which will allow the composition to form a set bond. In a preferred embodiment, at least one of said substrates comprise a plastic material. In a particularly preferred embodiment, one substrate is plastic and one substrate is a paper stock material.

### DETAILED DESCRIPTION OF THE INVENTION

The invention involves the use of foamed water-based adhesive useful in the manufacture of packaging materials including but not limited to bags.

Adhesives used in accordance with the invention comprise synthetic and/or natural ingredients. When modified and mechanically agitated with air, these adhesives form highly stable, consistent foams that can be applied to a substrate and used to effectively bond the substrate to a second identical, similar or different substrate. Benefits of using the foamed adhesive of the invention include improved economics and performance, such as reduced penetration into substrates, reduced moisture and faster set times. It has been discovered that adding air bubbles to the adhesive significantly reduces moisture content without affecting adhesive performance. Faster drying times and a substantial reduction in incidence of warping and/or wrinkling encountered in prior art methods are possible when bags are prepared in accordance with the invention.

Adhesives for use in the practice of the invention include, but are not limited to, synthetic resins, natural rubbers, starches and/or dextrins. The adhesives of the invention can be formulated as an emulsion or a solution. Adhesives comprising single copolymer emulsions as well as blends of two or more copolymers are contemplated for use in the practice of the invention. Particularly preferred are adhesives that comprise a mixture of polymer emulsions, more preferable a mixture of vinyl acetate containing polymer emulsions. Preferred polymer emulsions will comprise a vinyl acetate component. More preferable the polymer emulsions will comprise a vinyl acetate component and an acrylic component.

Vinyl acetate containing emulsions include vinyl acetate homopolymers, emulsions comprising vinyl acetate copolymers such as ethylene vinyl acetate or propylene vinyl acetate, and various mixtures thereof.

Particularly preferred are mixtures of vinyl acetate containing emulsions and vinyl acetate copolymer containing emulsions. Included are ethylene vinyl acetate, copolymers of vinyl acetate and other acrylates such as 2-ethylhexylacrylate, and vinyl acetate homopolymers. Most particularly preferred are emulsions comprising a vinyl acetate polymer and/or copolymer and an acrylic copolymer. Preferably the acrylic copolymer component present in each polymer emulsion present in the polymer mixture is different. Preferably one acrylic is dioctylmaleate and the other acrylic is butyl acrylate.

One preferred emulsion comprises a terpolymer of vinyl acetate/ethylene/dioctylmaleate. Another preferred emulsion comprises a vinyl acetate/butyl acrylate copolymer. Particularly preferred adhesives comprise a mixture of these polymer emulsions.

Ethylene vinyl acetate and propylene vinyl acetate copolymers are well known commercially available materials. Exemplary techniques for their preparation are described in, for example U.S. Pat. Nos. 2,200,429 and 2,396,785. The percent of vinyl acetate in the copolymer will generally range from about 4% to about 80% by weight and have a melt index of from about 0.1 to about 1000 grams per minute. The vinyl acetate copolymer typically will be polyvinylalcohol stabilized.

The use of ethylene vinyl acetate has been discovered to be particularly advantageous. Ethylene vinyl acetate copolymers are available from Air Products Polymers under the tradename Airflex® (e.g., AirFlex 400 which has a Tg of 0° C. and an ethylene content of approximately 20% by weight in the copolymer). Still others are available from National Starch and Chemical Company under the tradename DUR-O-SET®).

As described above, preferred adhesives will typically comprise, in addition the vinyl acetate containing component, an acrylic copolymer containing component. Typical acrylic copolymers useful in the practice of the invention comprise acrylic monomers such as the C₁-C₁₂ esters of acrylic or methacrylic acid a well as ethylenically unsaturated monomers containing functional groups. Nonlimiting examples of acrylic copolymers include methyl methacrylate/butyl acrylate/2,2-hydoxyethylhexyl acrylate copolymers and methyl methacrylate/ethyl acrylate/2,2-hydoxyethylhexyl acrylate copolymers and the like. Both high and low molecular weight acrylic polymers are contemplated for use.

The acrylic polymer contemplated for use in the practice of the invention is formed of acrylate monomers. Both high and low Tg alkyl acrylates may be used. Low transition temperature monomers are those having a Tg of less than about 0° C. Included are alkyl acrylates that have up to about 18 carbon atoms in the alkyl group, preferably from about 4 to about 10 carbon atoms in the alkyl group. Such alkyl acrylates include butyl acrylate, amyl acrylate, hexyl acrylate, 2-ethylhexyl acrylate, isooctyl acrylate, decyl acrylate, dodecyl acrylates, isomers thereof, and combinations thereof. A preferred alkyl acrylate for use in the practice of the invention is butyl acrylate.

While the monomer system making up the acrylic copolymer may be solely based on low Tg alkyl acrylate ester monomers, inclusion of high Tg monomers and/or functional comonomers, in particular carboxy-containing functional monomers, and/or, even more preferably, hydroxy-containing functional monomers is preferred.

High Tg monomer components which may be present, and in some embodiments are preferably present, include methyl acrylate, ethyl acrylate, isobutyl methacrylate, and/or vinyl acetate. The high Tg monomers may be present in a total amount of up to about 50% by weight, preferably from about 5 to about 50% by weight, even more preferably from about 10 to about 40% by weight, based on total weight of the hybrid polymer.

The acrylic polymer may also comprise one or more functional monomers. Preferred are carboxy and/or hydroxy functional monomers. Carboxy functional monomers may be present in the polymer in an amount of up to about 7% by weight, more typically from about 1 to about 5% by weight, based on the total weight of the monomers. Useful carboxylic acids preferably contain from about 3 to about 5 carbon atoms and include, among others, acrylic acid, methacrylic acid, itaconic acid, and the like. Acrylic acid, methacrylic acid and mixtures thereof are preferred.

The acrylic copolymer may comprises hydroxy functional monomers such as hydroxyalkyl (meth)acrylate esters, and acrylic polymers used to form the backbone of the invention are preferably acrylic ester/hydroxy (meth)alkyl ester copolymers. Specific examples of hydroxy functional monomers include hydroxyethyl acrylate, hydroxypropyl acrylate, hydroxyethyl methacrylate and hydroxypropyl methacrylate. Hydroxy functional monomers are generally used in an amount of from about 1 to about 10%, preferably from about 3 to about 7%.

Other comonomers can be used to modify the Tg of the acrylic polymer or to further enhance adhesion to various surfaces. Such comonomers include N-vinyl pyrrolidone, N-vinyl caprolactam, N-alkyl (meth)acrylamides such as t-octyl acrylamide, cyanoethylacrylates, diacetoneacrylamide, N-vinyl acetamide, N-vinyl formamide, glycidyl methacrylate and allyl glycidyl ether.

Other components typical of adhesive compositions may be added to the foamable compositions. Said additives include, but are not limited to, plasticizers, acids, waxes, synthetic resins, tackifiers, defoamers, preservatives, bases such as sodium hydroxide, fillers, dyes, pigments, UV indicators, crosslinkers and other additives commonly used in the art.

The adhesive may also contain a surface-active agent. Examples of surface-active agents include anionic, cationic, amphoteric, or nonionic surfactants, or mixtures thereof. Suitable anionic surfactants include, alkyl sulfonates, alkylaryl sulfonates, alkyl sulfates, sulfates of hydroxylalkanols, alkyl and alkylaryl disulfonates, sulfonated fatty acids, sulfates and phosphates of polyethoxylated alkanols and alkylphenols, and esters of sulfosuccinic acid. Suitable cationic surfactants include, alkyl quaternary ammonium salts, and alkyl quaternary phosphonium salts. Suitable non-ionic surfactants include the addition products of 5 to 50 moles of ethylene oxide adducted to straight-chain and branched-chain alkanols having 6 to 22 carbon atoms, alkylphenols, higher fatty acids, higher fatty acid amines, primary or secondary higher alkyl amines, and block copolymers of propylene oxide with ethylene oxide, and mixtures thereof. When used, the surface active agent will typically be added in amounts up to about 20% by weight, based on the foamable composition as a whole. More usually from amounts of from about 0.05 to about 20% by weight, and preferably at from 0.2 to 2% by weight.

Suitable fillers are those fillers known in the art as adhesives fillers and include polysaccharides, calcium carbonate, clay, mica, nut shell flours, silica, talc and wood flour. A clay filler may typically be used to prepare adhesives for use in the practice of the invention. The addition of a filler allows for foam generated to remain consistent and stable for several hours.

Preservatives for use herein include those conventionally used in aqueous adhesives such as benzoates, amides and fluorides such as sodium fluoride. Also included are the hydroxybenzoic acid esters such as p-hydroxybenzoic acid methyl ester or p-hydroxybenzoic butyl ester. Commercially available preservatives which may be used in the practice of the invention include KATHON LXE sold by Rohm & Haas Company and Nipacide OBS sold by Clariant. The preservative will generally be included in amounts of from 0.05% to about 0.2% by weight.

Preferred adhesives are foamable adhesives comprising from about 40 to about 80% by weight of a polymer emulsion comprising a vinyl acetate copolymer and an acrylic copolymer and from about 10 to about 40% by weight of a polymer emulsion comprising vinyl acetate and an acrylic copolymer.

The foamable adhesive composition of the invention is foamed by the addition of energy, by means known in the art such as, but not limited to, by mechanical and/or chemical means. Air or other gases are added to the foamable adhesive composition along with the addition of said energy to produce a stable, consistent foamed adhesive. Preferably air is used to produce the foamed adhesive. The adhesive foam may be produced by mechanical means such as mechanical stirring or agitation, introduction of gases or by chemical means.

The amount of air dispersed in the adhesive can vary depending on the particular formulation, but will generally be from about 10% (by volume) up to about 50% (by volume) or greater.

The adhesive may be used to manufacture packaging materials in both laminating and heat sealing applications.

The foamed adhesive of the invention is particularly well suited for use in the preparation of multi-wall bags having a pinch closable end and an opposite closed or open end. This type of bag is known in the industry as a pinched bottom open mouth bag. Alternatively, both ends of the bag may be pinch closable. Both flat tube style bags and bags having gussets may be manufactured in accordance with the invention. Also encompassed are block bottom and satchel bottom bags. Many forms of bag containers formed of multiple plies are known and are encompassed by the invention. These include bags to hold pet food, rice, chemical powders, powdered milk, sugar and other dry commodities. Also included are microwave bags including but not limited to popcorn bags.

Other types of packaging containers encompassed by the invention include laundry soap boxes, fabric dryer sheet containers, industrial wraps and food containers. Food containers are defined herein as including any wrapper, bag, box, cup or other paper product capable of covering, holding or containing a food product, whether hot or cold, wet or dry. Examples include but are not limited to hamburger wrappers, candy wrappers, pizza and cereal boxes, and bags for potato chips, peanuts and pet food.

While the adhesive finds particular use as a laminating adhesive to bond together the plies of multi-ply packaging materials, particularly preferred articles of manufacture are multi-ply bags. The adhesive may also be used to bond together the lap seams and/or to secure a handle component to the bag.

The packaging material of the invention is typically a paper product. Paper products are defined herein as any article of manufacture, at least a portion of which comprises paper. The paper product may be made totally of paper or partially of paper. The invention encompasses paper products made of either single or multiple layers, e.g., a paper laminate, plastic/paper laminate. The adhesive may be applied on one or both sides, and may be coated on the side to be laminated. Included are plastic/paper laminates and plastic/paper/plastic laminates.

The invention is further illustrated by the following non-limiting example.

### EXAMPLE

An adhesive comprising 56.9% by weight of an ethylene/vinyl acetate/acrylic terpolymer (46% vinyl acetate, 36% dioctylmaleate, 17% ethylene) and 22% by weight of a vinyl acetate/acrylic copolymer (25% vinyl acetate and 75% butyl acrylate), 10.3% by weigh of a plasticizer (Benzoflex 50, a 50:50 blend of diethylene/dipropylene glycol dibenzoate available from Velsicol and from Kalama Chemical), 8.3% by weight of an aliphatic hydrocarbon tackifier (Picconol, available from Hercules, Inc.), 0.15% by weight of a preservative (Kathon LX, available from Rohm and Haas Co.) and 0.2% by weight of a defoamer (Foamaster NXZ, available from Cognis Corp.) was prepared by mixing the ingredients using conventional mixing means for one hour. The adhesive was foamed by mechanical means to a 30% by volume foam level.

The foamed adhesive was used to coat the surface of a paper substrate. Immediately following coating of the adhesive onto the paper substrate the adhesive present on the paper substrate was brought in contact with a plastic substrate. The welded substrates were allowed to set for one hour at room temperature. Bond strength and % fiber test was tested. 100% fiber tear was observed.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A foamed adhesive composition comprising a polymer having a vinyl acetate component and an acrylic component, and polymer blends thereof.

2. The adhesive of claim 1 comprising a blend of at least a first polymer emulsion and a second polymer emulsion.

3. The adhesive of claim 2 wherein said first polymer emulsion comprises a vinyl acetate/ethylene/dioctylmaleate terpolymer.

4. The adhesive of claim 3 wherein said second polymer comprises a vinyl acetate/butyl acrylate copolymer.

5. An article of manufacture comprising the adhesive of claim 1.

6. The article of claim 5 which is a packaging material.

7. The article of claim 6 wherein said packaging material is a bag.

8. The packaging material of claim 6 comprising a first substrate having opposing first and second major surfaces and at least one second substrate having opposing first and second major surfaces, wherein at least one of the first and second major surfaces of said first substrate is bonded to at least one of the first and second major surface of the second substrate with said adhesive.

9. A package for housing materials, said package comprising at least one side wall, said side wall comprising at least an inner ply and an outer ply, wherein a first ply is bonded to a second ply with the foamed adhesive of claim 1.

10. The package of claim 9 wherein at least one of said inner ply, outer ply, first and/or second ply is made of a paper material.

11. The package of claim 9 wherein at least one of said inner ply, outer ply, first and/or second ply is made of a plastic material.

12. The package of claim 9 wherein the adhesive comprises a blend of at least a first polymer emulsion and a second polymer emulsion.

13. The package of claim 12 wherein said first polymer emulsion comprises a vinyl acetate/ethylene/dioctylmaleate terpolymer and said second polymer comprises a vinyl acetate/butyl acrylate copolymer.

14. A method for bonding materials together which comprises applying the foamed adhesive composition of claim 1 to a first substrate, bringing a second substrate in contact with the adhesive composition applied to the first substrate, and subjecting the applied composition to conditions which will allow the composition to form a set bond.

15. The method of claim 14 wherein at least one of said substrates comprise a plastic material.

16. The method of claim 15 wherein one substrate is plastic and one substrate is a paper material.
